(19) United States
(12) Patent Application Publication
(10) Pub. No.: US 2005/0073144 A1
(43) Pub. Date: Apr. 7, 2005

(54) Blowout adaptor

(76) Inventors: William LaPointe, Portsmouth, RI (US); Paul Roussel, Mansfield, MA (US); Kim Petti, East Greenwich, RI (US); Richard M. Oster, Barrington, RI (US)

Correspondence Address: David D. Lowry, Esq.;Brown Rudnick Berlack Israels LLP, One Financial Center, Boston, MA, 02111, US

(21) Appl. No.: 10/956,796

(22) Filed: Oct. 1, 2004

Related U.S. Application Data
(60) Provisional application No. 60/507,880, filed on Oct. 1, 2003.

(51) Int. Cl. F16L 35/00

(52) U.S. Cl. 285/3

(57) ABSTRACT

An adaptor that can connect a gas cylinder to a separate gas fitting, with a high level of safety. Vents in the threaded portion allow excess pressure to be relieved before the gas cylinder is removed from the adaptor, thereby preventing unexpected release of pressure which can injure users and bystanders. An insulating outer jacket provides an easily gripped surface and prevents contact with cold surfaces caused by gas discharge. The adaptor is easy to manufacture and includes a sturdy design to withstand heavy use without breaking.

### RELATED APPLICATIONS

The present application claims priority from U.S. provisional application 60/507,880 filed on Oct. 1, 2003, which is incorporated herein by reference.

### FIELD OF THE INVENTION

This invention is directed towards gas fitting connections, and more particularly towards pneumatic connectors with safety venting features.

### BACKGROUND

Adaptors are often used when connecting gas lines together. Some examples are inflation devices for automotive and bicycle tires, other examples include the periodic flushing and cleaning out of a gas metering system. The system consists of a nozzle with an orifice of a predetermined diameter. During the normal operation of the gas metering system it is possible for the orifice to become restricted by airborne contaminants. This restriction can cause poor performance and improper fuel to air mixture ratio. An adaptor can use compressed gas from a cylinder to clear out the restriction in the nozzle orifice assembly.

Gas cylinders pose a danger to users if a cylinder is unscrewed from an adaptor before all pressure has been released. In a small size CO₂ cylinder cartridge, once the sealed end has been pierced, the cylinder will continue to expel gas after it has been unscrewed. The release of the gas under pressure is dangerous to all bystanders, and has the potential to fire the cylinder off like a projectile.

Further, some present-day adaptors have a right angle formed in the adaptor. This creates a more circuitous route for the gas to follow, and also makes the adaptor more complicated and fragile. Such right-angle adaptors need to be reinforced to prevent breakage during normal use. Also, as a cylinder cartridge expels gas, both the cylinder and the adaptor will get cold by the expansion of compressed gas. The cylinder and adaptor can get so cold as to cause of risk of ‘freezer burn’ to a user, or at least cause the parts to stick to a user's hand.

### SUMMARY

The present invention is directed towards an adaptor that can connect a gas cylinder to a separate gas fitting, with a high level of safety. The present invention includes vents to allow excess pressure to be relieved before a gas cylinder is removed from the adaptor, thereby preventing unexpected release of pressure which can injure users and bystanders. The present invention also includes a novel design that is simple to manufacture, provides a sturdy unbreakable structure, and can insulate a user from freezer burn caused by gas expansion.

An illustrative embodiment of the present invention includes a technique for piercing a CO₂ cylinder with a combination plastic and metallic adapter. The adapter accepts the threaded end of a gas (such as CO₂) cylinder. The adapter includes a piercing pin centrally located within it and also has dual o-rings to maintain a positive seal interface with the external threaded cylinder. The metallic portion of the adapter is encased by a rigid molded plastic ring that has knurls 90 degrees apart to allow it to be torqued without slipping in the user's hand. The device has a safety feature that allows pressurized gas to flow in a direct path without any excessive back pressure. The adapter also includes proximate the O-ring seal a venting geometry feature that allows the discharge of the pressurized gas prior to the removal of the cylinder. When the adapter is fully positioned on the cylinder it allows the discharge of pressurized gas which for example provides a cleaning action in a fuel feed system.

### BRIEF DESCRIPTION OF THE DRAWINGS

The foregoing and other features and advantages of the present invention will be more fully understood from the following detailed description of illustrative embodiments, taken in conjunction with the accompanying drawings in which:

FIG. 1A is a perspective view of an illustrative embodiment of the present invention;

FIG. 1B is a side view of the illustrative embodiment of FIG. 1A;

FIG. 1C is an end view of the illustrative embodiment of FIG. 1A;

FIG. 1D is a sectional view of the illustrative embodiment along the cutting line shown in FIG. 1C;

FIG. 2A is a perspective view of an alternative embodiment of the present invention;

FIG. 2B is a side view of the alternative embodiment of FIG. 2A; and

FIG. 2C is an end view of the alternative embodiment of FIG. 2A.

### DETAILED DESCRIPTION

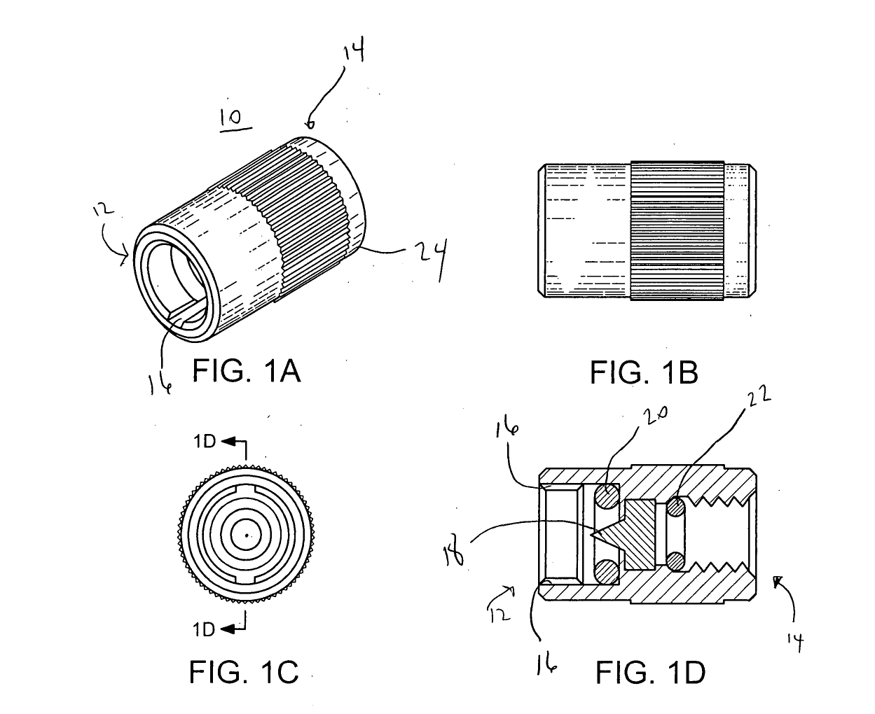

The present invention is directed towards an adaptor device that can connect a gas cylinder or hose to a separate gas fitting, with a high level of safety. FIG. 1A-D shows an illustrative embodiment 10 of the present invention. To use, a CO₂ or other gas cartridge is installed on one end 12, while the other end 14 is then connected to the separate gas fitting. A feature of the present invention is one or more safety vents 16 located on one side 12 of the device 10. In the illustrative embodiment these are in the form of vent groves 16 that run generally parallel with the length of the device body. These vent groves 16 allow the gas under pressure to escape before the cylinder can be removed, thus avoiding possible injury to the operator or bystanders (i.e. the release of the gas under pressure could make a CO₂ cylinder a projectile if it is inadvertently disconnected). In the illustrative embodiment, it has been found that with unscrewing torque applied to a gas cartridge, the gas cartridge will unscrew before the connection to the gas fitting on the end 12, therefore vents are not required on the other side 14. However it is within the scope of the invention to install vent groves 16 on the other side, or on both sides. Further, a different geometry or cross section may be used for the safety vents 16.

Another feature of the present invention is the construction of the device 10 provides some thermal insulation between the gas path and the other surface of the device. This helps protect users from the intense cold that can occur when gas is depressurized. This feature will be discussed further in reference to the various embodiments.

Turning to the illustrative embodiment shown in FIG. 1A-1D, the device end 12 has a ⅜×24UN-2B thread, which accepts a standard gas cartridge. When screwed on, the seal on the cartridge is pierced by a hardened pin 18. The pin 18 may have a hex shape, which advantageously allows good penetration of the end of the gas cartridge, and then allows easy flow of gas once the cartridge is pierced or is backed off (unscrewed) a minimal amount, such as a quarter turn. The pin 18 may also have a conical shape, to allow some functionality as a control valve, whereby the cartridge can be minimally unscrewed to allow the gas flow to commence. Other shapes for the piercing pin 18 are possible, including a hollow pin to allow gas to flow through the pin itself. A standard O-ring or alternative geometry washer 20 maintains a proper seal to prevent gas leakage. The gas flows through the device (not shown) to the other end 14. For the illustrative embodiment, the device installs on the threaded end of a Schrader fitting, this having a 0.312-32 UN-2B thread. An O-ring or other washer 22 seals the connection on that side to prevent leaking.

During the discharge of gas from the cartridge, the cold temperature can cause the O-rings 20, 22 to shrink, and they can then fall out of the device when it is detached. The present invention includes a feature of using larger ring or gasket sizes and/or a different shape (for example flat) for one or both O-rings 20, 22. Alternatively, the O-rings are installed deeper within the device 10 than typically required. This feature prevents the O-rings from being dislodged from their proper position.

In typical use, first the end 14 of the device 10 is screwed onto the gas fitting, and then a gas cartridge is screwed onto the end 12. If a user tries to unscrew the cartridge before it has fully emptied, the gas will safely vent through the vents 16. As previously described, unscrewing torque applied to a gas cartridge will cause the gas cartridge to unscrew before the connection to the gas fitting on the end 12. Further, a locking mechanism may be used to prevent unscrewing of the device on the end 12 unless the gas cartridge is unscrewed first, or unless the pressure inside has reached equilibrium with the outside.

The embodiments shown in FIGS. 1A-D and 2A-C are constructed using a molded plastic knurled nut 24 around an internal metal 26 construction. This allows the user more grip for installation and removal. It also insulates the user from the cold temperature that results when the CO₂ is released into the metal device body. The manufacturing is performed by machining (or alternatively molding) the metal insert 26. The outer plastic body 24 is molded, and while still warm, slipped over the metal portion whereupon it shrinks when cooled. The metal insert may include ridges or other surface features (not shown) to provide a more secure connection. Alternatively adhesives or connectors such as screws etc. may be used to hold the plastic portion 24 to the metal portion 26. Other materials may be used in the manufacturing, including plastic for the metal insert 26.

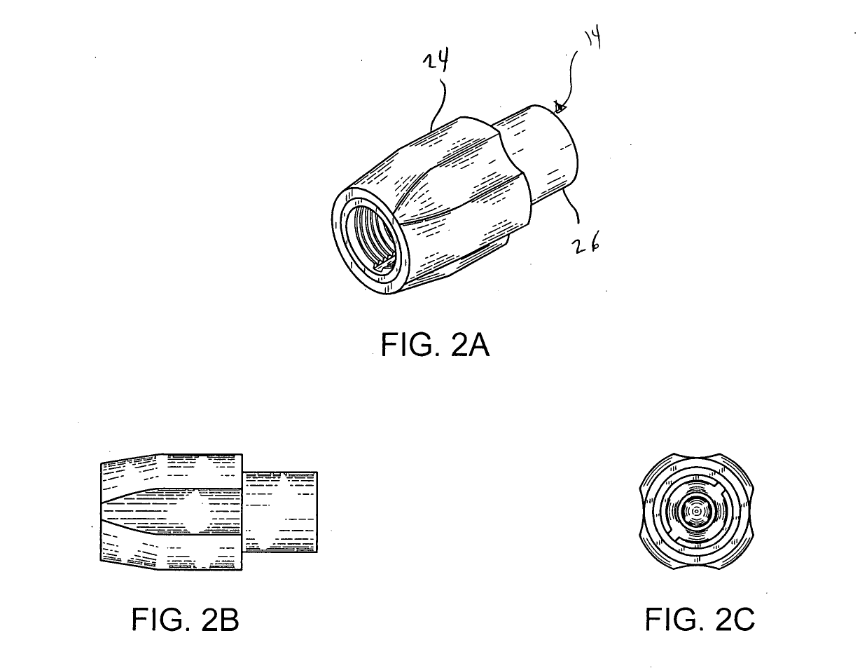

FIG. 2 shows an alternative embodiment of the device 10. This embodiment can be used to flush out gas lines such as the propane line and burner used to produce carbon dioxide in mosquito attracting and trapping devices. The metal portion 26 is extended on the end 14 that connects to the gas fitting, to allow easier attachment to a gas fitting that is somewhat inconvenient to access, for example is on a recessed panel. The molded plastic exterior 24 allows a firm grip when installing the adaptor or screwing or unscrewing a gas cylinder. Further, the exterior 24 helps insulate again the temperature of the gas inside. This also avoids condensation on the plastic exterior which might affect the user's grip. The exterior is curved in on one end to provide a better grip, and also to assist in allowing a gas cartridge to be screwed on or unscrewed. The molded plastic portion 24 preferably a bright color, such as fluorescent orange, to allow easy finding of the device. Since this device can be used outside, the bright color allows the device to stand out in case it is dropped in the grass or brush. Further, the color can provide a warning that the device has been left on a gas fitting, which assists in making sure the device is used properly.

Although the present invention is described for use as a blowout adaptor, the present invention can be used in many situations where an adaptor between a gas cartridge or cylinder and an inlet or outlet is needed. Some examples of other applications include inflation such as automobiles and bicycle tires. For use with bicycles, the compact and sturdy design of the present invention allows it to be carried along with a compact gas cartridge for tire inflation that is much smaller and lighter than a typical bike pump. Other examples of applications include gas pressurizing for seltzer bottles and whipped cream.

Although the invention has been shown and described with respect to illustrative embodiments thereof, various other changes, omissions and additions in the form and detail thereof may be made therein without departing from the spirit and scope of the invention.

1. A gas fitting adaptor, for connecting a gas cylinder to a gas fitting; comprising:
an inlet port including a interior threaded surface to accept a threaded connection of said gas cylinder, wherein said interior threaded surface include at least one grove formed in said interior threaded surface said at least one grove running generally perpendicular to a direction of threads of said interior threaded surface;
a hardened pin situated within said inlet port, said hardened pin to pierce a seal on said gas cylinder when said gas cylinder is connected to said inlet port;
an outlet port situated on an end of said gas fitting adaptor generally opposite said inlet port, said outlet port in fluid connection with said inlet port to allow gas to flow from said inlet port to said outlet port; and
an outer surface including indentations to provide a graspable surface for applying torque to said gas fitting adaptor.

2. The gas fitting adaptor of claim 1 wherein said hardened pin includes a hex shape.

3. The gas fitting adaptor of claim 1 wherein said at least one groove allows a gas to escape from within said gas fitting adaptor when said gas cylinder is partially unscrewed from said inlet port.

4. The gas fitting adaptor of claim 1 wherein said outer surface is comprised of a material with at least some thermal insulating properties.

5. The gas fitting adaptor of claim 4 wherein said outlet port extends beyond said outer surface.

6. The gas fitting adaptor of claim 4 wherein said inlet port and outlet port are manufactured from one material, and then inserted into said outer surface to form a singular unit.

7. The gas fitting adaptor of claim 1 further including:
a first sealing ring located in said inlet port and proximate said hardened pin, to provide a gas tight seal between said inlet port and said gas cylinder; and
a second sealing ring located in said outlet port, to provide a gas tight seal between said inlet port and said gas fitting;
wherein at least one of said first sealing ring or second sealing ring is oversized to prevent dislodging upon a decrease in temperature.

8. The gas fitting adaptor of claim 1 wherein said gas fitting adaptor is utilized to clear debris from a gas path in connection with said gas fitting.

9. A method of connecting a gas cartridge to a gas fitting, said method comprising:
installing a gas fitting adaptor onto said gas fitting, said gas fitting adaptor including:
an inlet port including a interior threaded surface to accept a threaded connection of said gas cartridge, wherein said interior threaded surface include at least one grove formed in said interior threaded surface said at least one grove running generally perpendicular to a direction of threads of said interior threaded surface;
a hardened pin situated within said inlet port, said hardened pin to pierce a seal on said gas cartridge when said gas cartridge is connected to said inlet port;
an outlet port situated on an end of said gas fitting adaptor generally opposite said inlet port, said outlet port in fluid connection with said inlet port to allow gas to flow from said inlet port to said outlet port; and
an outer surface including indentations to provide a graspable surface for applying torque to said gas fitting adaptor;
screwing a gas cartridge onto said inlet port; and
unscrewing said gas cartridge from said inlet port, wherein any remaining pressurized gas within said gas cartridge will vent through said at least one grove in said interior threaded surface.

10. A gas fitting adaptor, for connecting a gas cylinder to a gas fitting to clear out a gas path; comprising:
an inlet port including a interior threaded surface to accept a threaded connection of said gas cylinder, wherein said interior threaded surface include at least one grove formed in said interior threaded surface said at least one grove running generally perpendicular to a direction of threads of said interior threaded surface, said at least one groove allows gas to escape from within said gas fitting adaptor when said gas cylinder is partially unscrewed from said inlet port;
a hardened pin situated within said inlet port, said hardened pin to pierce a seal on said gas cylinder when said gas cylinder is connected to said inlet port;
a first sealing ring located in said inlet port and proximate said hardened pin, to provide a gas tight seal between said inlet port and said gas cylinder;
an outer surface comprising a material with at least some insulating properties, said outer surface including indentations to provide a graspable surface for applying torque to said gas fitting adaptor;
an outlet port situated on an end of said gas fitting adaptor generally opposite said inlet port, and extending beyond said outer surface, said outlet port in fluid connection with said inlet port to allow gas to flow from said inlet port to said outlet port; and
a second sealing ring located in said outlet port, to provide a gas tight seal between said inlet port and said gas fitting;
wherein at least one of said first sealing ring or second sealing ring is oversized to prevent dislodging upon a decrease in temperature.
